(19) United States
(12) Patent Application Publication
(10) Pub. No.: US 2012/0005755 A1
(43) Pub. Date: Jan. 5, 2012

(54) INFECTION INSPECTION SYSTEM, INFECTION INSPECTION METHOD, STORAGE MEDIUM, AND PROGRAM

(75) Inventors: Shigeki KITAZAWA, Tokyo (JP); Seiji FUJII, Tokyo (JP); Yoshiharu SAIGA, Tokyo (JP); Koichi YAHAGI, Tokyo (JP); Takaaki NAKANO, Tokyo (JP); Takaya KATO, Tokyo (JP)

(73) Assignees: MITSUBISHI ELECTRIC CORPORATION, Chiyoda-ku (JP); The Bank of Tokyo-Mitsubishi UFJ, Ltd., Chiyoda-ku (JP); MITSUBISHI ELECTRIC INFORMATION NETWORK CORP., Chiyoda-ku (JP)

(21) Appl. No.: 13/074,685

(22) Filed: Mar. 29, 2011

(30) Foreign Application Priority Data
Jun. 30, 2010 (JP) 2010-148670

(51) Int. Cl. G06F 11/00

(52) U.S. Cl. 726/24

(57) ABSTRACT

When detecting a traffic abnormality, an abnormality detection apparatus 131 notifies a malware infected terminal that has caused the traffic abnormality to a terminal whitelist generation apparatus 133, the terminal whitelist generation unit 133 generates a whitelist indicating software allowed to be installed to the malware infected terminal and setting of a reference terminal device 134 managed not to be infected with the malware, and loads a inspection object extraction program into the malware infected terminal, the inspection object extraction program detects software and setting in the malware infected terminal, and inspects whether or not the detected software and setting coincide with the software and the setting in the whitelist, it is highly likely that software or a setting not coinciding with the whitelist is associated with the malware, by analyzing the software or the setting, the malware may be promptly identified.

### TECHNICAL FIELD

The present invention relates to a technology for promptly cleansing malware from a terminal device.

The malware collectively refers to malicious and harmful software or malicious and harmful codes such as computer viruses, computer worms, back doors, keyloggers, spywares, and Trojan Horses, which have been generated with an intention of performing a wrongful and harmful operation.

### BACKGROUND ART

Conventionally, as a technology of coping with the malware, which is a malicious program, a technology of automatically applying an update patch or anti-virus countermeasure software has been commonly introduced. The update patch (being a module for fixing a bug of a program) takes care of vulnerability of an operating system or software which may be abused by the malware.

As shown in Patent Document 1, for example, a system (generally referred to as a quarantine system) for maintaining the software and the anti-virus countermeasure software in a most recent state is devised. This system is devised so as to have a terminal connected to a network be highly immune to the malware.

A method of performing a quarantine process on a user terminal device is devised (in Patent Document 2, for example). In this method, a gateway apparatus installed at a connecting point (an exchange station) to the Internet and connected to the user terminal device detects whether or not the user terminal device is infected with the malware. When the infection is detected, the gateway apparatus disconnects the user terminal device from the Internet, and connects the user terminal device to a restoration support device (installed within the exchange station) by a VPN (Virtual Private Network) to perform the quarantine process on the user terminal device.

According to Patent Document 2, even when monitoring means such as the anti-virus countermeasure software is not provided on the user terminal device, infection of the terminal device with the malware is detected by a communication pattern transmitted from the user terminal, and the malware is thereby cleansed by the quarantine process.

In addition, restoration support audio service using an IP (Internet Protocol) telephone can be received. Thus, even when a user of the terminal device does not have particular knowledge about the malware, flowing of harmful communication (communication infected with the malware or denial of service attack communication) to the Internet from the terminal device infected with the malware is prevented. In addition, the malware may be cleansed from the user terminal device.

### RELATED ART DOCUMENTS

[Patent Document 1] JP-2007-299342A

[Patent Document 2] JP-2007-102697A

### SUMMARY OF INVENTION

### Technical Problem

In the conventional quarantine systems (in Patent Documents 1 and 2), since security measures for the terminal device connected to the network are maintained in the most recent state, the terminal device is highly immune to malware infection and the malware is cleansed when the terminal device infected with the malware is detected. However, there is a problem that a zero-day attack (attack where adequate countermeasure means is not established) and unknown malware cannot be coped with.

The present invention mainly aims to solve the above-mentioned problems. A main object of the present invention is to implement a configuration in which analysis for cleansing the malware from the terminal device may be promptly performed when a terminal device is highly likely to be infected with malware.

### Solution to Problem

An infection inspection system according to the present invention is an infection inspection system that performs inspection of a terminal device that may be infected with malware. The system may include:

an inspection reference information management unit that stores inspection reference information indicating software properly installed to the terminal device as proper software; and

an inspection execution unit that detects software which is present in the terminal device and inspects whether or not the detected software in the terminal device coincides with the proper software indicated by the inspection reference information stored in the inspection reference information management unit.

### Advantageous Effect of Invention

In the present invention, it is inspected whether or not the proper software properly installed to one terminal device coincides with the software detected from another terminal device.

For this reason, software that does not coincide with the proper software is extracted from the another terminal device infected with the malware. It is highly likely that the extracted software is associated with the malware. Then, by performing analysis of the extracted software, the malware may be promptly identified.

### BRIEF DESCRIPTION OF DRAWINGS

FIG. 1 is a diagram showing a configuration example of a system in a first embodiment;

FIG. 2 is a diagram showing a configuration example of a terminal whitelist generation apparatus in the first embodiment;

FIG. 3 is a diagram explaining a whitelist generation process in the first embodiment;

FIG. 4 is a flowchart showing a flow of whitelist information generation in the first embodiment;

FIG. 5 is a diagram showing a configuration example of a reference terminal device in the first embodiment;

FIG. 6 is a table showing an example of a whitelist in the first embodiment;

FIG. 7 is a flowchart diagram showing an operation example of the system in the first embodiment;

FIG. 8 is a flowchart diagram showing an operation example of the system in the first embodiment;

FIG. 9 is a diagram explaining a whitelist generation process in a second embodiment;

FIG. 10 is a diagram showing a whitelist generation process in a third embodiment;

FIG. 11 is a diagram showing an example of an inspection object extracting configuration in the first embodiment;

FIG. 12 is a diagram showing an example of the inspection object extracting configuration in the first embodiment;

FIG. 13 is a diagram showing an example of the inspection object extracting configuration in the first embodiment; and

FIG. 14 is a diagram showing a configuration of hardware such as the terminal whitelist generation apparatus in the first embodiment or a terminal whitelist generation apparatus in each of the second and third embodiment and a fourth embodiment, and the like.

### DESCRIPTION OF EMBODIMENTS

### First Embodiment

In first to fourth embodiments, a description will be directed to an infection inspection system capable of promptly performing analysis when a malware main program is removed from a terminal device.

More specifically, in the infection inspection system, software that is properly installed to the terminal device and a setting according to which the software normally operates are held as inspection reference information. When a traffic abnormality occurs inside an enterprise, software that is present in a terminal device that has caused abnormal traffic is detected, and contents of the detected software and the inspection reference information are compared. Besides, a setting of the terminal device that has caused the abnormal traffic is detected, and contents of the detected setting and the inspection reference information are compared.

Then, when software or a setting that is not included in the inspection reference information is found, the software or the setting is highly likely to be associated with malware. Accordingly, by continuing the analysis focusing on the software or the setting, the malware may be promptly cleansed.

In the first to fourth embodiments, a description will be given using an enterprise's internal network as an example. The system according to this embodiment may be applied to an internal network of a public office or a predetermined organization as well.

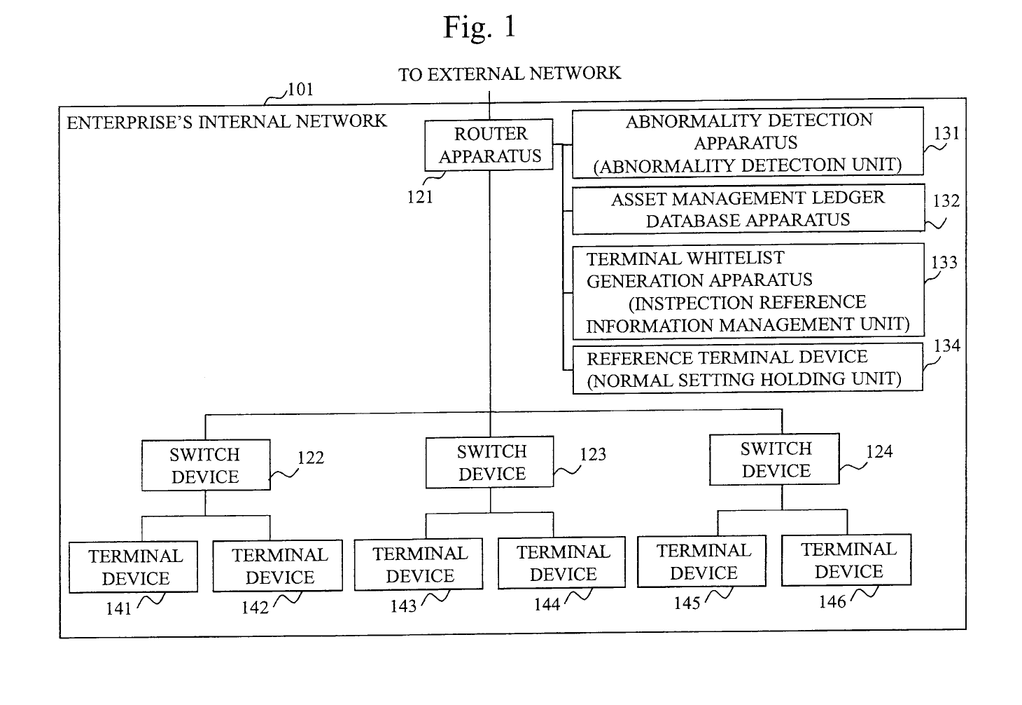

FIG. 1 shows a configuration example of the system in this embodiment.

Referring to FIG. 1, an enterprise's internal network 101 is a network disposed within the enterprise, and includes networks such as a LAN (Local Area Network) and an intranet.

The enterprise's internal network 101 includes a router apparatus 121, switch devices 122 to 124, and a communication cable that connects the router apparatus 121 and the switch devices 122 to 124.

Each of the router apparatus 121 and the switch devices 122 to 124 periodically generates traffic information.

The traffic information will be described later.

Terminal devices 141 to 146 are connected to the switch device 122 to 124. Each of the terminal devices 141 to 146 is used by a user in the enterprise for business. Each of the terminal devices 141 to 146 accesses another terminal devices or accesses an external network (Internet, a node-to-node connection network, or the like) through the router apparatus 121 and a corresponding one of the switch device 122 to 124. Basic configurations of the terminal devices 141 to 146 are assumed to be managed by the system manager of the enterprise's internal network 101.

The user additionally installs necessary software to each of the terminal devices 141 to 146 according to content of business.

The same assumption as described above is established in a thin client environment as well.

It is also assumed that an update patch (module for fixing a bug of a program) determined to be necessary by the system manager of the enterprise's internal network 101 is managed by patch management means (update management system) not shown in FIG. 1, so that the update patch is installed to each of the terminal devices 141 to 146.

Each of the terminal devices 141 to 146 may possibly be infected with malware.

An abnormality detection apparatus 131 monitors a behavior of traffic that flows through the enterprise's internal network 101, and detects occurrence of abnormal traffic.

The abnormality detection apparatus 131 is an example of an abnormality detection unit in the infection inspection system.

The behavior of traffic is defined as a time-series characteristic variation of a value obtained by aggregating the traffic information collected from each of the apparatus and the devices (router apparatus and switch devices) that constitute the enterprise's internal network 101.

As a method of aggregating the traffic information, aggregation of the number of generation of data per unit time or a data transfer amount per unit time without setting any condition may be considered. Alternatively one can conceive of aggregating the number of data per unit time or a data transfer amount per unit time, corresponding to any one of, or any combination of a source IP address, a destination IP address, a transmission source port number, and a destination port number. The traffic behavior indicates the time-series characteristic variation of the value obtained as a result of the aggregation as described above.

When a characteristic variation amount obtained by aggregating the traffic information exceeds a predetermined level, the abnormality detection apparatus 131 determines that a traffic abnormality has occurred.

For example, when the data transfer amount per unit time has abruptly increased in a given unit time, the abnormality detection unit 131 determines that the traffic abnormality has occurred.

The traffic information herein means packet dump data or flow statistic information for each packet transmitted from each terminal device.

The packet dump data is recorded data of the packet that has flown at a certain observation point on the network, without alteration.

Data communication by the terminal device is defined in terms of the concept of a flow, and the flow statistic information is recorded statistic information such as the number of transmitted packets, the number of received packets, a data transmitted byte amount, and a data received byte amount for each flow of communication performed by the terminal device.

Common examples of the flow statistic information are NetFlow, sFlow, or the like.

The packet dump data and the flow statistic information both include observation time information and information on the source IP address, the destination IP address, the transmission source port number, and the destination port number.

When each of the router apparatus 121 and the switch devices 122 to 124 included in the enterprise's internal network 101 does not include a function of generating the traffic information, a sensor dedicated to generating the traffic information may be disposed on the enterprise's internal network 101 to collect the traffic information.

An asset management ledger database apparatus 132 manages installed software including an operating system, for each of the terminal devices 141 to 146 connected to the enterprise's internal network 101.

Information that is managed by the asset management ledger database apparatus 132 includes at least the terminal device ID (host name and MAC address), user ID (user name, user specific number, telephone number, and e-mail address) and a type and a version of the software including the operating system installed in each of the terminal device.

A reference terminal device 134 is a terminal device that is arranged not to be infected with the malware.

The reference terminal device 134 is physically or logically disconnected from the switch devices 122 to 124 and the terminal devices 141 to 146 so as not to be infected with the malware.

All the software (operating system, middleware, applications, update patches, and the like) properly installed to the terminal devices 141 to 146 connected to the enterprise's internal network 101 is installed to the reference terminal device 134, and a setting for normally operating each software is set at the reference terminal device 134.

The software installed to the reference terminal device 134 will be hereinafter also referred to as proper software.

The setting set at the reference terminal device 134 will be hereinafter also referred to as normal setting.

The normal settings of the reference terminal device 134 include various settings such as hash values, variables, values, and parameters for the software installed to the respective terminal devices to normally operate.

The normal setting of the reference terminal device 134 are defined by the system manager.

As described above, the proper software is installed to the reference terminal device 134. The reference terminal device 134 holds the normal settings. The reference terminal device 134 is an example of a normal setting holding unit in the infection inspection system.

In a normal state not infected with the malware, one of the proper software installed to the reference terminal device 134 is installed to each of the terminal devices 141 to 146. The same settings as the normal settings of the reference terminal device 134 are set at each of the terminal devices 141 to 146.

A terminal whitelist generation apparatus 133 generates a list (whitelist) of information on software and setting that are allowed to be installed to the terminal device doubted to be infected with the malware, based on the information in the asset management ledger database apparatus 132.

The information (whitelist information) on the software and the setting allowed to be installed to each of the terminal devices 141 to 146, which provides basis for the whitelist, is generated and accumulated by the terminal whitelist generation apparatus 133, by referring to the reference terminal device 134.

The whitelist information is information indicating the setting (normal setting) for normally operating the proper software, for each proper software installed to the reference terminal device 134.

As described above, the whitelist information held by the terminal whitelist generation apparatus 133 is information indicating the proper software and the normal setting of the reference terminal device 134, and is an example of inspection reference information.

The terminal whitelist generation apparatus 133 selects the whitelist information corresponding to the software allowed to be installed to the terminal device doubted to be infected with the malware, and combines the selected whitelist information to generate the whitelist.

As described above, the whitelist is a collection of the selected whitelist information, and the whitelist is a collection of the inspection reference information that has been selected.

The terminal whitelist generation apparatus 133 is an example of an inspection reference information management unit in the infection inspection system.

The terminal whitelist generation apparatus 133 is an example of a first computer in an infection inspection method.

FIG. 1 describes only the configuration necessary for concisely explaining the content of this embodiment, and does not limit a network configuration when actually configuring a network to which this embodiment is applied.

This embodiment focuses on a malware countermeasure process starting from detection of a traffic abnormality by the abnormality detection apparatus 131. Thus, no particular limitation is imposed on a method of implementing the abnormality detection apparatus 131 in this embodiment.

It is, however, assumed that the abnormality detection apparatus 131 includes at least a function of detecting a traffic abnormality and a function of identifying the IP address of the terminal device of an origin of the abnormal traffic.

The terminal device that has caused the abnormal traffic is the one that may have been infected with the malware, and is to be inspected using the whitelist.

Hereinafter, the terminal device that has caused the abnormal traffic, namely, the terminal device that may have been infected with the malware is also referred to as a malware infected terminal.

The malware infected terminal is to be inspected using the whitelist and is an example of a terminal device to be inspected.

In addition to the above-mentioned functions, the abnormality detection apparatus 131 may further include a function of identifying the MAC (Media Access Control) of the terminal device from the identified IP address, and at least one of functions to isolate the malware infected terminal from the enterprise's internal network 101 based on the IP address and the MAC address (the functions such as filtering of specific communication or linkdown of a connection port using the router apparatus or the switch device that forms the enterprise's internal network, and filtering using a personal firewall on the terminal).

Next, details of the terminal whitelist generation apparatus 133 will be described.

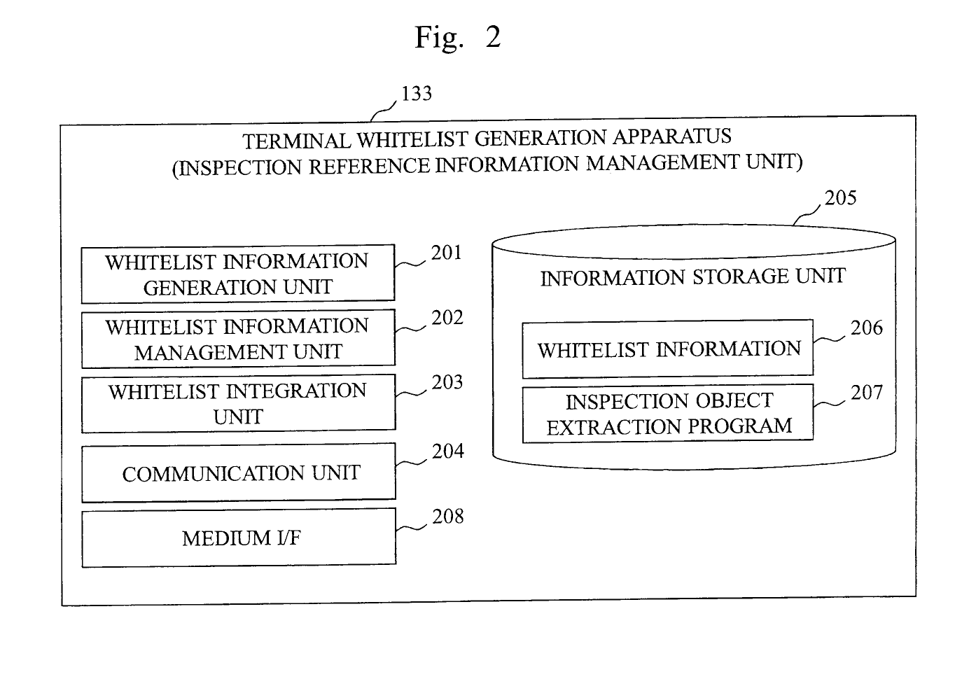

FIG. 2 shows an example of a configuration of the terminal whitelist generation apparatus 133.

Referring to FIG. 2, a whitelist information generation unit 201 includes a function of generating the whitelist information on each software, each file, and each specific setting information, based on the reference terminal device 134.

As described above, the whitelist information is generated for each proper software of the reference terminal device 134.

A whitelist information management unit 202 includes a function of managing the whitelist information generated by the whitelist information generation unit 201.

The whitelist information management unit 202 stores the whitelist information generated by the whitelist information generation unit 201 in an information storage unit 205, for example, and reads one of the whitelist information to be integrated by a whitelist integration unit 203 from the information storage unit 205.

The whitelist integration unit 203 integrates the whitelist information to generate the whitelist used for extracting the main body of the malware and a suspicious change in the settings from the malware infected terminal.

A communication unit 204 performs communication with the abnormality detection apparatus 131, the asset management ledger database apparatus 132, the reference terminal device 134 and the like while managing a physical interface, a transmission control procedure, a network connection procedure, and the like.

The information storage unit 205 stores whitelist information 206 generated by the whitelist information generation unit 201.

The information storage unit 205 stores an inspection object extraction program 207.

The inspection object extraction program 207 performs inspection of the malware infected terminal using the whitelist.

The inspection object extraction program 207 is stored in a predetermined recording medium, together with the whitelist generated by the whitelist integration unit 203. Then, when the recording medium is installed in the malware infected terminal, the inspection object extraction program 207 is loaded into a memory on the malware infected terminal.

Then, the inspection object extraction program 207 is started by a CPU on the malware infected terminal, detects software that is present in the malware infected terminal, and inspects whether or not the software in the malware infected terminal coincides with the proper software shown in the whitelist. Further, the inspection object extraction program 207 detects setting of the malware infected terminal and inspects whether or not the setting of the malware infected terminal coincides with the normal setting shown in the whitelist.

Details of operation of the inspection object extraction program 207 will be described later.

A medium I/F (Interface) 208 is an interface for the recording medium in which the inspection object extraction program 207 and the whitelist are stored.

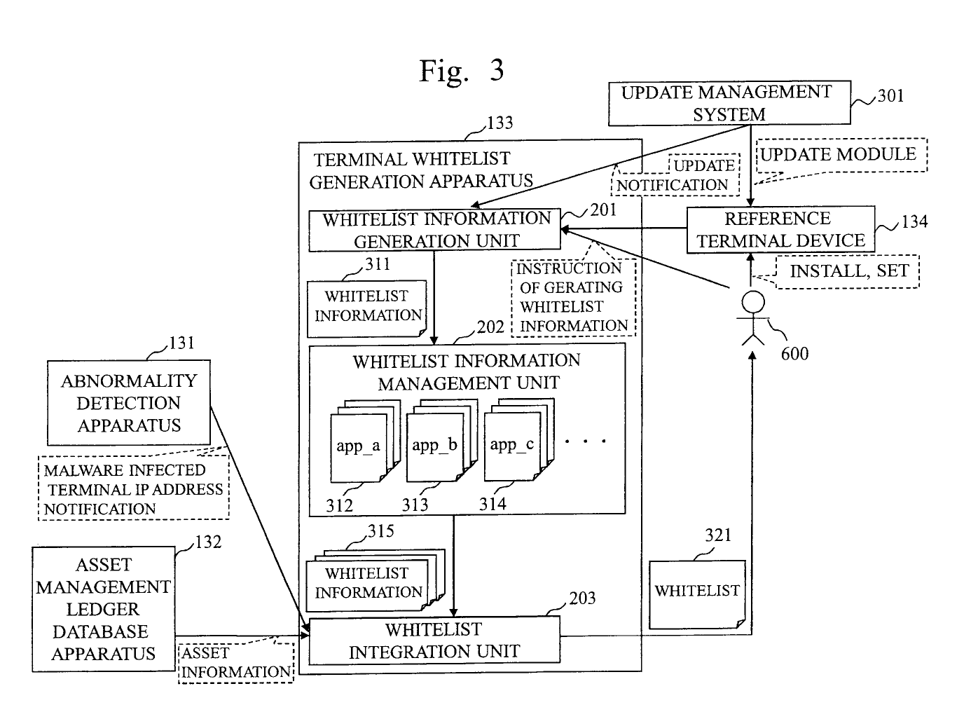

Next, input/output data and an internal process of the terminal whitelist generation apparatus 133 will be described, using FIG. 3.

Referring to FIG. 3, an update management system 301 is a system that performs management so that a patch program determined to be necessary by a system manager 600 of the enterprise's internal network 101 is installed to each of the terminal devices 141 to 146.

Reference numerals 311 to 315 denote whitelist information, while reference numeral 321 denotes a whitelist.

As shown in FIG. 3, the whitelist information generation unit 201 in the terminal whitelist generation apparatus 133 inputs information on the proper software and the normal settings installed to the reference terminal device 134 through the communication unit 204 from the reference terminal device 134, and generates the whitelist information 311 for each proper software, based on an instruction of generating the whitelist information from the system manager 600.

Then, the whitelist information management unit 202 obtains each of the whitelist information 312 to 314 generated by the whitelist information generation unit 201, and stores the whitelist information 312 to 314 in the information storage unit 205.

When a traffic abnormality is detected and the malware infected terminal of the origin of the traffic abnormality is identified by the abnormality detection apparatus 131, the whitelist integration unit 203 receives notification of the IP address (or the MAC address) of the malware infected terminal from the abnormality detection apparatus 131, and then notifies the IP address (or the MAC address) to the asset management ledger database apparatus 132 through the communication unit 204.

Then, the whitelist integration unit 203 obtains a list of software that is allowed to be installed to the malware infected terminal from the asset management ledger database apparatus 132 through the communication unit 204.

Then, the whitelist integration unit 203 requests the whitelist information management unit 202 to read the whitelist information corresponding to the software shown in the obtained list of software. The whitelist information management unit 202 reads the corresponding whitelist information 315 from the information storage unit 205, and supplies the whitelist information 315 to the whitelist integration unit 203.

The whitelist integration unit 203 combines the whitelist information 315 received from the whitelist information management unit 202 to generate the whitelist 321.

Then, the whitelist integration unit 203 stores the inspection object extraction program 207 and the whitelist 321 in the recording medium.

The recording medium in which the inspection object extraction program 207 and the whitelist 321 are stored is attached to the malware infected terminal by the system manager 600.

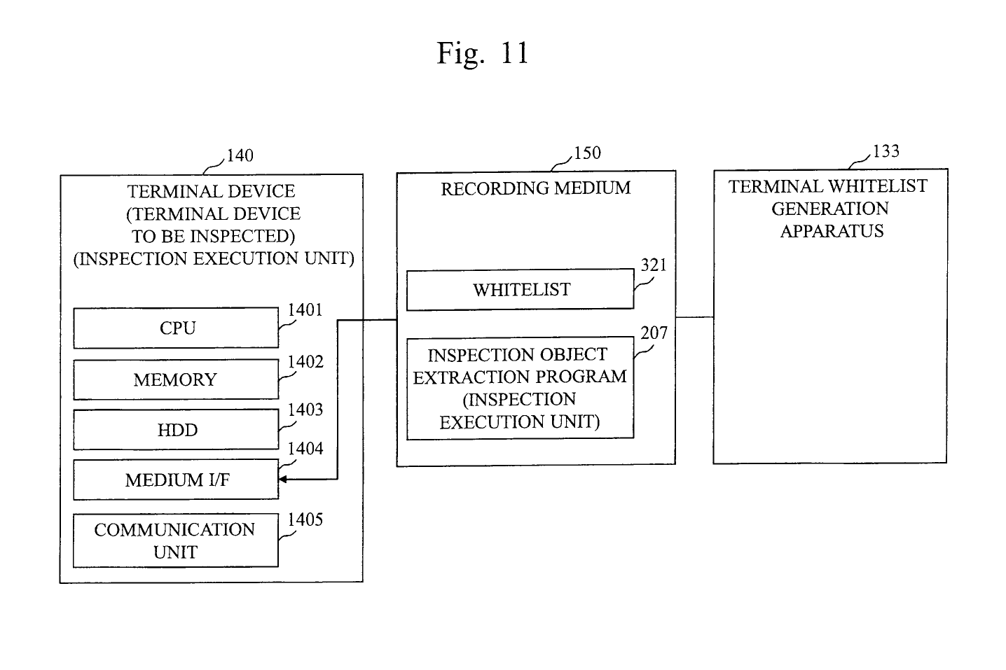

FIG. 11 shows a relationship among the terminal whitelist generation apparatus 133, a recording medium 150, and a terminal device 140.

Referring to FIG. 11, the inspection object extraction program 207 and the whitelist 321 are stored in the recording medium 150.

The terminal device 140 is the malware infected terminal which is to be inspected.

The terminal device 140 is one of the terminal devices 141 to 146.

The terminal device 140 is an example of the terminal device to be inspected, and is a device that executes the inspection object extraction program 207. Together with the inspection object extraction program 207, the terminal device 140 serves as an example of an inspection execution unit in the infection inspection system.

The terminal device 140 is also an example of a second computer in the infection inspection method.

The terminal device 140 includes a CPU (central Processing Unit) 1401, a memory 1402, an HDD (Hard Disk Drive) 1403, a medium I/F 1404, and a communication unit 1405.

The recording medium 150 in which the inspection object extraction program 207 and the whitelist 321 have been stored by the terminal whitelist generation apparatus 133 is attached to the medium I/F 1404 of the terminal device 140 by the system manager 600, and is loaded into the memory 1402 of the terminal device 140 through the medium I/F 1404. The CPU 1401 executes the inspection object extraction program 207.

The inspection object extraction program 207 detects software that is present in the terminal device 140, and inspects whether or not the detected software in the terminal device 140 coincides with the proper software shown in the whitelist 321. Besides, the inspection object extraction program 207 detects setting of the terminal device 140, and inspects whether or not the detected setting of the terminal device 140 coincide with the normal setting shown in the whitelist 321.

When the software or the setting that does not coincide with content of the whitelist 321 is present in the terminal device 140, a list of the software or the setting that does not coincide with the content of the whitelist 321 is stored in the recording medium 150.

Then, after completion of the inspection, the system manager 600 detaches the recording medium 150 from the medium I/F 140. The list in the recording medium 150 extracted by the inspection object extraction program 207 is sent to an anti-virus vendor, for example, to ask for an analysis of the malware with which the terminal device 140 is infected.

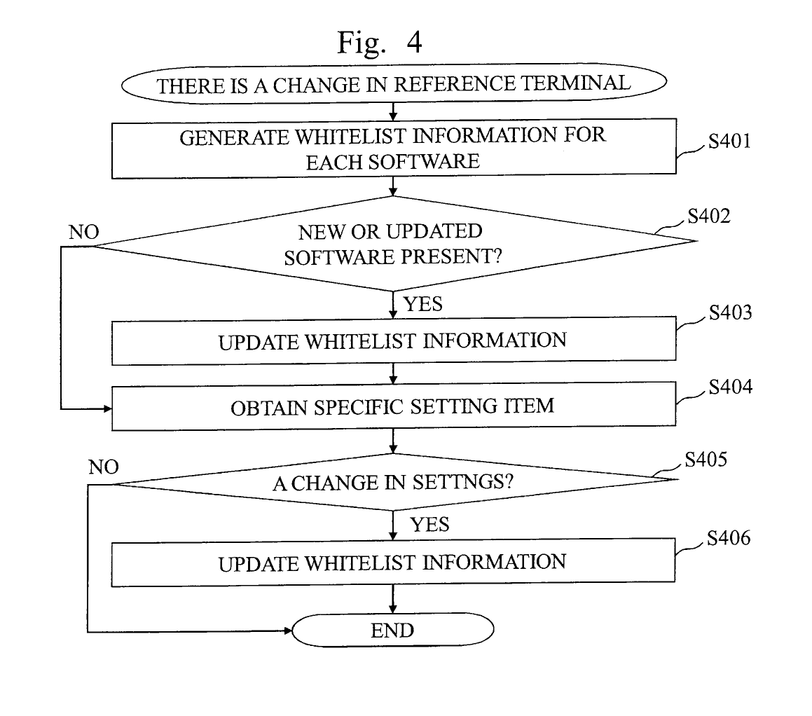

Next, a flow of generating whitelist information by the whitelist information generation unit 201 will be shown in FIG. 4.

The whitelist information generation unit 201 receives information indicating the proper software (file name and version) and the normal setting (hash value, installation path, specific set path, variable, and value) from the reference terminal device 134 through the communication unit 204.

Then, based on the information from the reference terminal device 134, the whitelist information generation unit 201 generates the whitelist information 311 on the software including the operating system and the settings that may have been installed to the terminal devices 141 to 146 (in step S401). Then, the whitelist generation unit 201 supplies the generated whitelist information 311 to the whitelist information management unit 202.

The whitelist information includes a file name, a version, a hash value, an installation path, a specific set path, a variable, and a value, as items, for example.

The version is identified from information on installation of applications managed by the operating system, based on the names of the applications.

The hash value is a data string of a fixed length that has been processed and output by a one-way collision function (MD5: Message Digest Algorithm 5, SHA: Secure Hash Algorithm, or the like) upon reception of file data.

The whitelist information is generated, for usually activated execution files, executable files on the hard disk, libraries (DLLs: Dynamic Link Libraries, device drivers), document files, a list of files stored under specific paths, and specific set paths on the reference terminal device 134.

The whitelist information is generated (updated) when updating of the software is applied to each of the terminal devices 141 to 146, when software is newly installed to each of the terminal devices 141 to 146, or when there is the software that is not currently used, as shown in steps S402 and S403 in FIG. 4.

The whitelist information is generated (updated) also when there is a change in the settings of each of the terminal devices 141 to 146, as shown in steps S404 to S406 in FIG. 4.

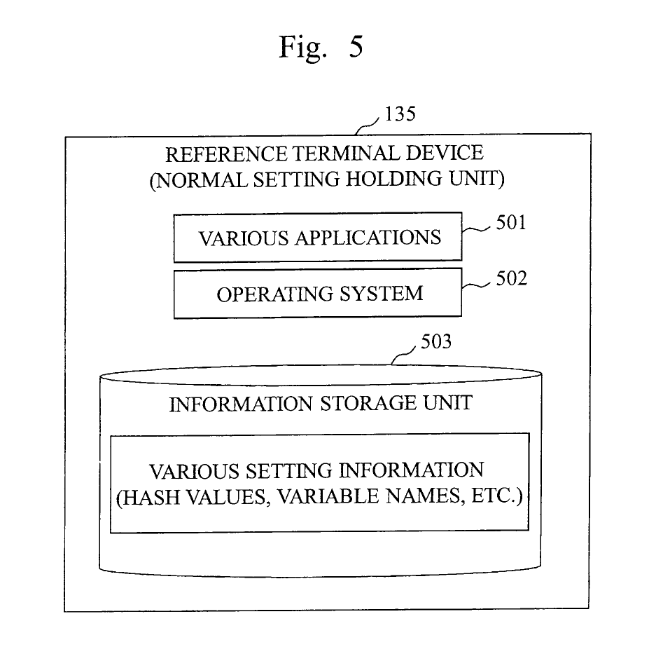

Now, a configuration example of the reference terminal device 134 will be shown in FIG. 5.

Like the terminal devices 141 to 146 connected to the enterprise's internal network 101, the reference terminal device 134 is managed by the update management system 301 (in FIG. 3) so that the patch (module for fixing a bug of a program) determined to be necessary by the system manger 600 of the enterprise's internal network 101 is installed to the reference terminal device 134.

Further, as described above, all the software (various applications 501 and an operating system 502) properly installed to the terminal devices 141 to 146 connected to the enterprise's internal network 101 is installed to the reference terminal device 134. Then, the reference terminal device 134 is set so that each software normally operates (various setting information in an information storage unit 503).

A plurality of the reference terminal devices 134 may be installed. When there is software that cannot be installed with other software to the same terminal device (such as the operating system and software competing against other software for resources on the terminal device), installation of the software over a plurality of the reference terminals is performed.

The reference terminal device 134 may be a physically identical device to each of the terminal devices 141 to 146, or may be implemented as a virtual machine that is fulfilled by a virtualization technology.

The reference terminal device 134 may be physically separated from the enterprise's internal network 101 to make sure that the reference terminal device 134 is not infected with the malware and then, may be directly connected to the terminal whitelist generation apparatus 133.

In this case, updating and a change in the settings of the reference terminal device 134 are manually performed by the system manager 600.

The reference terminal device may be logically separated from the enterprise's internal network 101 by additionally carrying out an access control measure based on a Firewall, an access permission IP address, and the user authority of the system manager, even though the reference terminal device is not physically separated from the enterprise's internal network 101.

In this case, as in the terminal devices 141 to 146, communication access control is applied so that only minimum necessary communication is allowed to update the software or the settings of the reference terminal device 134.

The whitelist information management unit 202 manages n generations (in which n is a natural number) of the whitelist information generated by the whitelist information generation unit 201 when the whitelist information is different according to the version of the software and a time period in which the whitelist information has been generated. The whitelist information older the n generations is deleted from the information storage unit 205.

The whitelist integration unit 203 receives IP address information on the malware infected terminal from the abnormality detection apparatus 131, notifies the IP address of the malware infected terminal to the asset management ledger database apparatus 132, and obtains information on a list of the software of the malware infected terminal from the asset management ledger database apparatus 132.

Then, the whitelist integration unit 203 selects the whitelist information corresponding to the software (software allowed to be installed to the malware infected terminal) shown in the list of the software from the asset management ledger database apparatus 132, for generation of the whitelist.

Then, the whitelist integration unit 203 requests reading of the selected whitelist information to the whitelist information management unit 202, and obtains the whitelist information from the whitelist information management unit 202 to generate the whitelist.

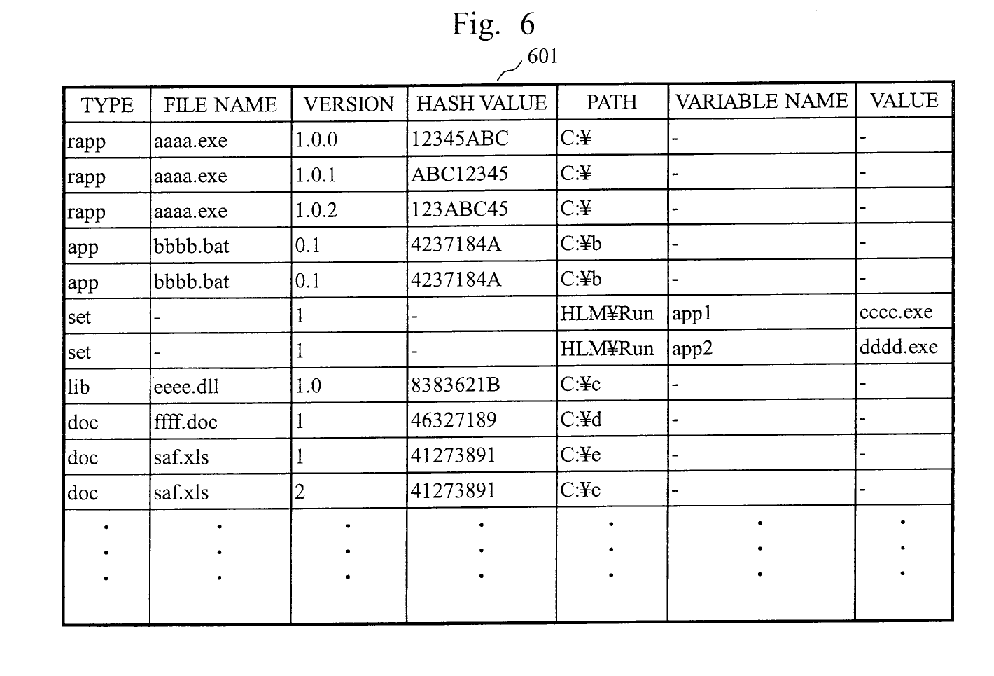

An example of a whitelist 601 generated by the whitelist integration unit 203 is shown in FIG. 6.

An item “type” included in the whitelist 601 is used to make distinction among objects for generation of the whitelist information (usually activated execution files, executable files on the hard disk, libraries, document files, a list of files stored under a specific path, and specific set paths).

For the object for generation of the whitelist information to which the version is not explicitly given (such as document files and settings) unlike the software or the library, the generation managed by the whitelist information management unit 202 may be used in place of a version in an item “version” included in the whitelist 601.

Referring to the column indicating the item “type” in FIG. 6, reference sign rapp indicates a usually activated execution file, reference sign app indicates an executable file on the hard disk, reference sign lib indicates a library (DLL, device driver), reference sign doc indicates a document file, and reference sign set indicates specific setting.

Further, an item “file name” and the item “version” indicate proper software, and items of “hash value”, “path”, “variable name”, and “value” in the white list 601 indicate normal settings for normally operating each proper software.

Details of each of the apparatus and the devices that are included in this embodiment were described so far.

Next, a sequence of flow when the operations of the respective apparatuses and devices function as the overall system will be described.

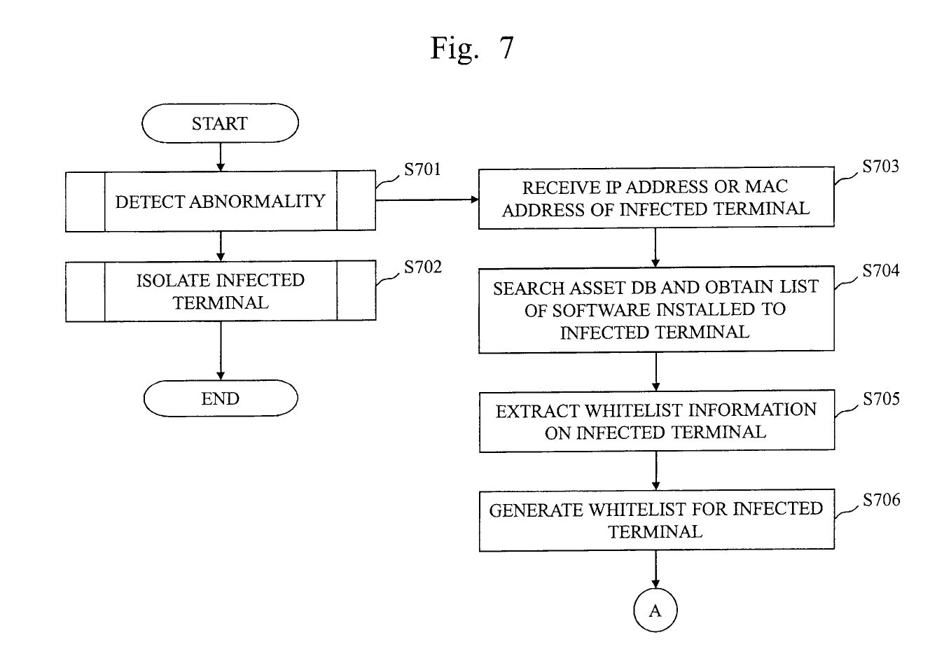

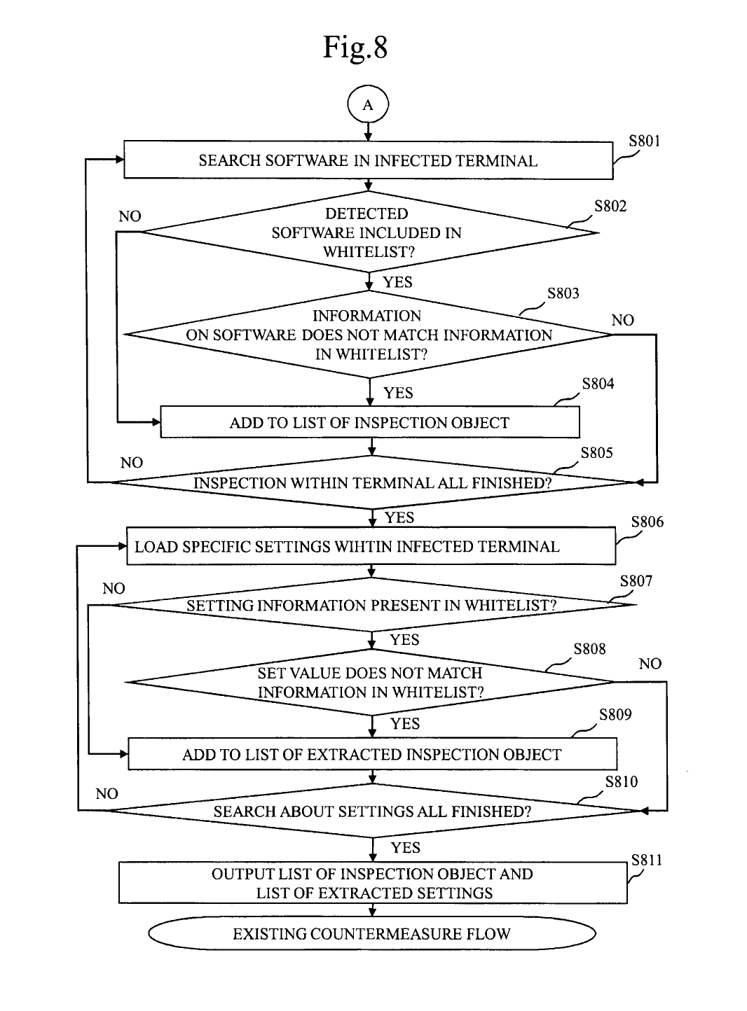

Each of FIGS. 7 and 8 is a flow diagram showing an operation example in this embodiment.

A detection of an abnormal behavior of traffic by the abnormality detection apparatus 131 starts the malware countermeasure process implemented in this embodiment.

When the abnormality detection apparatus 131 detects the abnormal traffic behavior (in step S701), the abnormality detection apparatus 131 identifies the IP address of the terminal device (malware infected terminal) that generates abnormal traffic.

The abnormality detection apparatus 131 further identifies the MAC address corresponding to the IP address of the malware infected terminal.

Then, the abnormality detection apparatus 131 performs a process of isolating the malware infected terminal from the enterprise's internal network 101 (in step S702), and notifies the IP address or the MAC address of the malware infected terminal to the terminal whitelist generation apparatus 133.

In the terminal whitelist generation apparatus 133, the communication unit 204 receives the IP address or the MAC address of the malware infected terminal (in step S703), and gives the IP address or the MAC address of the malware infected terminal to the whitelist integration unit 203.

Next, the whitelist integration unit 203 in the terminal whitelist generation apparatus 133 notifies the IP address or the MAC address received from the abnormality detection apparatus 131 to the asset management ledger database apparatus 132 through the communication unit 204, and then obtains a list of the software installed to the malware infected terminal from the asset management ledger database apparatus 132 (in step S704).

Next, the whitelist integration unit 203 requests the whitelist information management unit 202 to read whitelist information corresponding to the obtained list of software. The whitelist information management unit 202 reads the corresponding whitelist information from the information storage unit 205 (in step S705), and supplies the read whitelist information to the whitelist integration unit 203.

The whitelist integration unit 203 combines the whitelist information (whitelist information corresponding to the list of software installed to the malware infected terminal) obtained from the whitelist information management unit 202 to generate a whitelist.

The whitelist integration unit 203 stores the generated whitelist in the recording medium 150 (preferably, an unrewritable medium) together with the inspection object extraction program 207.

As described above, the inspection object extraction program 207 is a program which is for inspecting whether or not a file and a setting at the malware infected terminal coincide with the content of the whitelist, and identifying the file or the setting that does not coincide with the content of the whitelist.

The whitelist information supplied from the whitelist information management unit 202 corresponds to the software that is allowed to be installed to the malware infected terminal. The whitelist generated from these whitelist information indicates settings of the software allowed to be installed to the malware infected terminal.

For this reason, when an element that does not coincide with the software and the setting described in the whitelist is included as a result of inspection by the inspection object extraction program 207, the element is highly likely to be associated with the malware.

When the inspection object extraction program 207 includes a function of detecting and cleansing a route kit (program for hiding a malware file), accuracy of extracting a malware inspection object is further improved.

The system manager 600 connects the recording medium 150 to the malware infected terminal (terminal device 140 in FIG. 11) and executes the inspection object extraction program 207, thereby extracting the main body of the malware and a suspicious change in the settings.

The system manager 600 separately puts a result of extraction in the (writable) recording medium, sends the recording medium to the vendor and asks the vendor to analyze the result of extraction.

An operation example when the inspection object extraction program 207 is executed by the CPU 1401 of the terminal device 140 (malware infected terminal) is as shown in FIG. 8.

After reading the whitelist 321 in the recording medium 150 and loading the whitelist 321 into the memory 1402 in the terminal device 140, the inspection object extraction program 207 searches the software that is present in the terminal device 140 (in step S801), and determines whether or not the detected software coincides with the proper software included in the whitelist 321 (in steps 802 and 803).

In the process in step S801, the inspection object extraction program 207 searches for usually activated execution files, executable files, libraries (DLLs, device drivers), document files, and files stored under specific paths on the terminal device 140 that are to be inspected, in the memory and the hard disk in the terminal device 140 into which the software is installed, based on attributes of the files (execution files, libraries, document files, and the like).

When the detected software does not coincide with the proper software (No in step S802 or YES in step S803), the inspection object extraction program 207 adds the software detected in step S801 to a list of inspection objects (in step S804).

The list of inspection objects is temporarily stored in a predetermined storage region of the memory 1402 of the terminal device 140.

When inspection of all the software in the terminal device 140 is finished (YES in step S805), the inspection object extraction program 207 loads the settings of the terminal device 140 (setting information within the information storage unit 503 in FIG. 5) (in step S806), and determines whether or not the loaded setting coincide with the proper setting included in the whitelist 321 (in steps S807 and S808).

Determination as to whether or not the inspection of all the software has been finished in step S805 is made, according to whether or not the process in step S801 on all the files in the terminal device has been finished.

When the loaded setting does not coincide with the proper setting (No in step S807 or YES in step S808), the inspection object extraction program 207 adds the setting which has been loaded in step S806 and does not coincide with the proper setting to a list of extracted settings (S809).

In step S806, inspection object extraction program 207 refers to a set path on the terminal device 140, based on the specific set path included in the whitelist, thereby loads set variable and value.

The list of extracted settings is temporarily stored in a predetermined storage region in the memory 1402 of the terminal device 140.

When inspection of all the settings in the terminal device 140 is finished (YES in step S810), the inspection object extraction program 207 outputs the list of inspection objects and the list of extracted settings to the recording medium 150.

Determination as to whether or not the inspection of all the settings has been finished in step S810 is made, according to whether or not inspection of the variables and values for all the specific set paths included in the whitelist has been finished.

By performing the above steps, inspection of the terminal device 140 by the inspection object extraction program 207 is finished. The system manager 600 detaches the recording medium 150 from the terminal device 140, and gives the list of inspection objects and the list of extracted settings in the recording medium 150 to the vendor to ask for a detection of malware.

Herein, the result of extraction by the malware infected terminal by the system manager 600 is put in the recording medium 150 and is sent to the vendor. By setting the malware infected terminal so as to accept only communication from the inspection object extraction program 207 when the malware infected terminal is isolated, the result of extraction may be automatically or manually sent to the terminal whitelist generation apparatus 133.

That is, the terminal whitelist generation apparatus 133 does not store the inspection object extraction program 207 in the recording medium 150, together with the whitelist 321. The CPU of the terminal whitelist generation apparatus 133 activates the inspection object extraction program 207 in the information storage unit 205 and performs the processes shown in FIG. 8 through communication between the communication unit 204 of the terminal whitelist generation apparatus 133 and the communication unit 1405 of the terminal device 140 (malware infected terminal). The inspection object extraction program 207 of the terminal whitelist generation apparatus 133 extracts software in the terminal device 140 not included in the whitelist 321 and places the extracted software in the list of inspection objects, and extracts a setting in the terminal device 140 not included in the whitelist 321 and places the setting in the list of extracted settings.

Then, the list of inspection objects and the list of extracted settings are automatically or manually sent to the anti-virus vendor from the terminal whitelist generation unit 133 as an inspection object.

In this case, the terminal whitelist generation apparatus 133 is an example of the inspection execution unit in the infection inspection system.

In this case, the terminal whitelist generation apparatus 133 is also an example of the second computer in the infection inspection method.

In the example shown in FIG. 11, the inspection object extraction program 207 is also run on the malware infected terminal through the recording medium 150 by the system manager 600. An agent program which has a function comparable to that of the inspection object extraction program 207 may be installed to the terminal device in advance, and the agent program may be set to accept only communication between the terminal whitelist generation apparatus 133 and the agent program, when the malware infected terminal is isolated. Thereby the whitelist 321 generated by the terminal whitelist generation apparatus 133 may be sent to the agent program through communication.

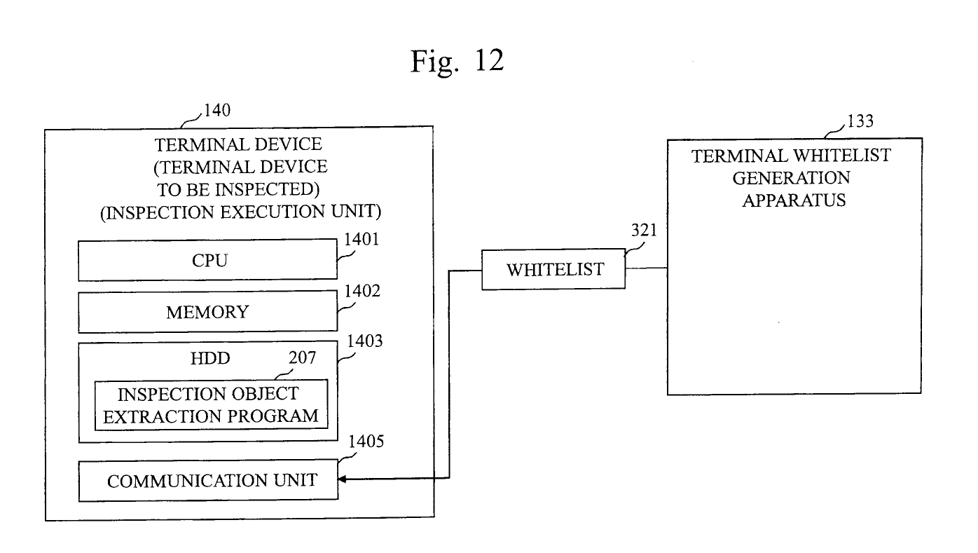

In this case, a configuration as shown in FIG. 12 may be conceived.

That is, the inspection object extraction program 207 is installed in the HDD 1403 of the terminal device 140 in advance. When the terminal device 140 is isolated as the malware infected terminal, the CPU 1401 activates the inspection object extraction program 207, and the communication unit 204 (not shown in FIG. 12) of the terminal whitelist generation apparatus 133 sends the whitelist 321 to the communication unit 1405 of the terminal device 140.

Then, the inspection object extraction program 207 in the terminal device 140 performs the processes shown in FIG. 8. The inspection object extraction program 207 thereby places the software in the terminal device 140 not included in the whitelist 321 in the list of inspection objects and places the setting of the terminal device 140 not included in the whitelist 321 in the list of extracted settings.

Then, the inspection object extraction program 207 of the terminal device 140 sends the list of inspection objects and the list of extracted settings to the communication unit 204 of the terminal whitelist generation apparatus 133 from the communication unit 1405.

The list of inspection objects and the list of extracted settings are automatically or manually sent to the anti-virus vendor from the terminal whitelist generation apparatus 133 as the inspection object.

In the example in FIG. 12, the terminal device 140 is an example of the inspection execution unit in the infection inspection system.

In the example in FIG. 12, the terminal device 140 is also an example of the second computer in the infection inspection method.

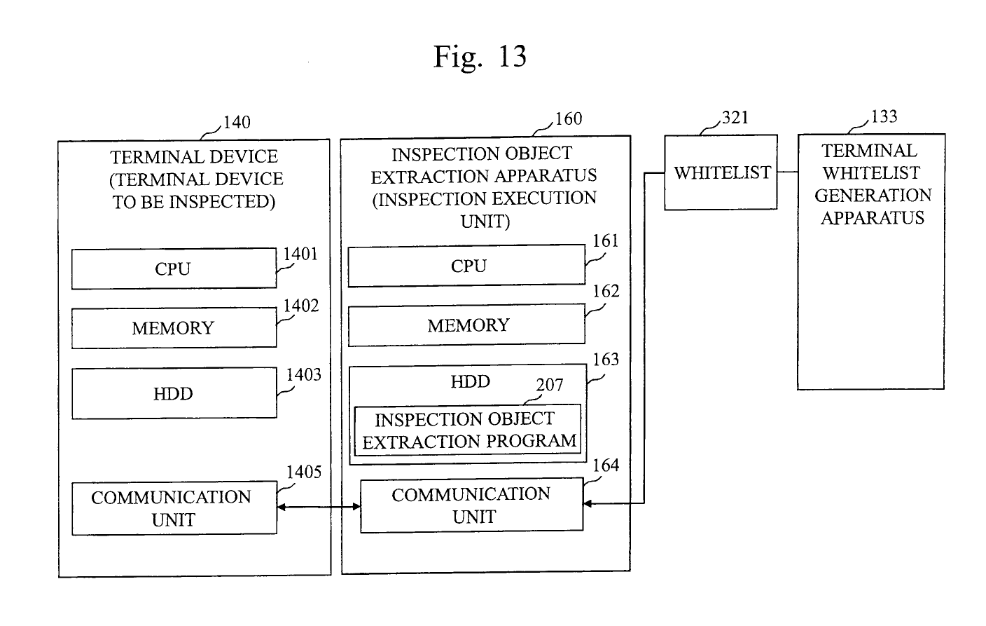

Alternatively, a configuration shown in FIG. 13 may be conceived.

Referring to FIG. 13, an inspection object extraction apparatus 160 is provided.

The inspection object extraction apparatus 160 is a portable computer, for example, may be brought in the vicinity of the terminal device 140, which is the malware infected terminal, and may perform near-distance wireless communication (such as ISO/IEC 18092) with the terminal device 140.

The inspection object extraction apparatus 160 includes a CPU 161, a memory 162, an HDD 163, and a communication unit 164.

The communication unit 164 may perform the near-distance wireless communication, as described above.

The inspection object extraction program 207 is installed in the HDD 163 in advance. When the terminal device 140 is isolated as the malware infected terminal, the CPU 161 activates the inspection object extraction program 207, and the communication unit 164 receives the whitelist 321 from the communication unit 204 (not shown in FIG. 13) of the terminal whitelist generation apparatus 133.

Then, when the inspection object extraction apparatus 160 is disposed in the vicinity of the terminal device 140, the communication unit 164 performs communication with the communication unit 1405 of the terminal device 140 to read the software and the settings in the terminal device 140.

The inspection object extraction program 207 performs the processes shown in FIG. 8 to inspect whether or not the software in the terminal device 140 coincides with the proper software shown in the whitelist 321, and to further inspect whether or not the setting in the terminal device 140 coincides with the proper setting shown in the whitelist 321. Then, the inspection object extract program 207 places the software in the terminal device 140 not included in the whitelist 321 in the list of inspection objects, and places the setting in the terminal device 140 not included in the whitelist 321 in the list of extracted settings.

Then, the inspection object extraction program 207 of the inspection object extraction apparatus 160 transmits the list of inspection objects and the list of extracted settings to the communication unit 204 of the terminal whitelist generation apparatus 133 from the communication unit 164.

The list of inspection objects and the list of extracted settings are automatically or manually sent to the anti-virus vendor from the terminal whitelist generation apparatus 133.

In the example in FIG. 13, the inspection object extraction apparatus 160 is an example of the inspection execution unit in the infection inspection system.

In the example in FIG. 13, the inspection object extraction apparatus 160 is also an example of a third computer in the infection inspection method.

Orders of inspection (order of inspection among the software and the order of inspection among the settings) done by the inspection object extraction program 207 may be provided in the whitelist information.

Priorities may be set, with attention paid to commonness (operating system and frequency of use) of the software and the settings among the terminal devices.

With this arrangement, by preferentially inspecting the software and the settings that are highly common, efficiency of extracting a malware inspection object may also be improved.

The efficiency of extracting a malware inspection object may also be improved by prioritizing with attention paid to importance of the software and the settings other than commonness of the software and the settings. For example, a high priority level is set for the software and the settings such as introduced software or the operating system that are important for operation of the terminal device, and a low priority level is set to the software and the settings such as the DLL and the document files that will not greatly influence the operation of the terminal device.

As described above, according to this embodiment, the malware infected terminal is isolated, based on the result of detection by the abnormality detection apparatus. In addition, the whitelist is prepared, based on the information in the terminal device (reference terminal device) not infected with the malware, and the main body of the malware is automatically identified from the malware infected terminal. Thus, the main body of the malware may be promptly analyzed.

For this reason, a countermeasure against new malware may be implemented quickly, so that a vulnerable period in which there is no countermeasure against the malware may be shortened.

Whitelist information on each software including the operating system is prepared in advance by the terminal whitelist generation apparatus, and the generated whitelist information is held and managed. When the malware infected terminal is detected, the information in the asset management ledger database apparatus is used.

Accordingly, the whitelist is generated without obtaining information from the malware infected terminal device that is not reliable. Thus, the whitelist that is highly reliable and is constituted from the minimum necessary information may be obtained.

With this arrangement, a highly accurate and high-speed malware inspection object extracting process is implemented.

Further, according to this embodiment, a program that is not basically allowed to be installed into the terminal device may also be extracted, like the malware. Unauthorized use of software may also be detected.

### Second Embodiment

In the first embodiment, whitelist information is managed by the whitelist information management unit 202 of the terminal whitelist generation unit 133 for each of software including the operating system.

Next, in this embodiment, a description will be directed to a method of increasing efficiency of a whitelist integration process by the whitelist integration unit 203 when software allowed to be installed to terminal devices 141 to 146 can be categorized by usage of each terminal device.

More specifically, in this embodiment, each of the terminal devices 141 to 146 belongs to either one of a plurality of categories.

Then, a terminal whitelist generation apparatus 133 groups proper software based on attributes of the proper software, and whitelist information (inspection reference information) on the proper software categorized as a same group is grouped. Then, each group of the whitelist information is managed associated with one of the categories.

When the malware infected terminal is detected by an abnormality detection apparatus 131, the terminal whitelist generation apparatus 133 selects the whitelist information of the group corresponding to the category to which the malware infected terminal belongs. Then, a whitelist is generated from the selected whitelist information.

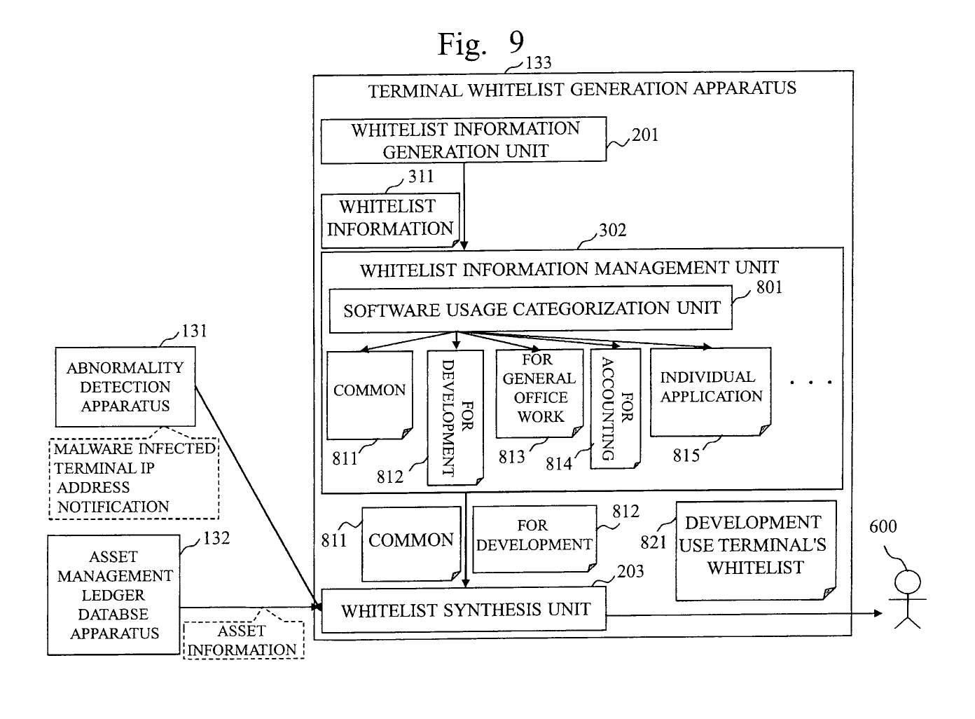

FIG. 9 shows a terminal whitelist generation apparatus 133 for implementing a second embodiment.

FIG. 9 corresponds to FIG. 3 shown in the first embodiment.

Referring to FIG. 9, a software usage categorization unit 801 includes a function of categorizing and grouping whitelist information generated by the whitelist information generation unit 201 based on the usage of each software.

Each of usage categorized whitelist information 811 to 815 contains the whitelist information on software categorized as a same usage.

Then, the usage categorized whitelist information 811 to 815 are managed in connection with categories of terminal devices 141 to 146.

In the example shown in FIG. 9, the terminal devices 141 to 146 are classified into the categories such as development, general office work, accounting, and the like. The whitelist information grouped for development 812 is managed in connection with the category “development” of the terminal device.

In the example in FIG. 9, the whitelist information grouped for common use 811 is in connection commonly with any category of the terminal device.

A development use terminal's whitelist 821 is a whitelist obtained by integrating the whitelist information grouped for common use 811 and the whitelist information grouped for development 812 when the terminal device classified into the category “development” becomes the malware infected terminal.

By inquiring the asset management ledger database apparatus 132, the whitelist integration unit 203 may know the category to which the malware infected terminal belongs. Then, the whitelist information corresponding to the category to which the malware infected terminal belongs may be thereby integrated to generate a whitelist for each terminal usage.

Referring to FIG. 9, inputs to a whitelist information generation unit 201 are the same as those in FIG. 3. Thus, illustration of the inputs is omitted.

In other words, illustration of arrows and the like related to an update management system 301, a reference terminal device 134, and generation of the whitelist information is omitted.

Next, operation of the terminal whitelist generation apparatus 133 in the second embodiment will be described, using FIG. 9.

The whitelist information generation unit 201 generates whitelist information by the same operation as in the first embodiment, and supplies the generated white information to a whitelist information management unit 302.

The whitelist information management unit 302 determines the usage of software which the whitelist information supplied from the whitelist information generation unit 201 is about, using the software usage categorization unit 801 newly added in the second embodiment, and categorizes and manages the whitelist information, as one of the usage categorized whitelist information 811 to 815.

The whitelist information may be categorized and managed, based on information presenting the departments where users belong, instead of the terminal device usage.

This arrangement is made for the following reason. Since the way of using each terminal device tends to be similar at one department to which users belong, a similar effect to that when the whitelist information is categorized for each terminal device usage may be expected.

Both of the terminal device usage and the information presenting the departments where users belong, may be used as categorization conditions.

It is assumed that managements on generations over the whitelist information is performed by the whitelist information management unit 302 in the second embodiment as well.

It is further assumed that, list information that defines for which usage the supplied whitelist information is used is set in advance as data in the software usage categorization unit 801 and is appropriately managed by the system manager 600.

When the IP address or the MAC address of the malware infected terminal is notified from the abnormality detection apparatus 131, the whitelist integration unit 203 notifies the IP address or the MAC address received from the abnormality detection apparatus 131 to the asset management ledger database apparatus 132. Then, the whitelist integration unit 203 receives asset information on the malware infected terminal from the asset management ledger database apparatus 132, determines the usage of the malware infected terminal, and extracts necessary whitelist information categorized by usage to generate a whitelist.

The asset management ledger database apparatus 132 includes information on the usages of the terminal devices and the information presenting the departments where terminal device users belong, in addition to the information described in the first embodiment.

The information on the usages of the terminal devices and the information presenting the departments where terminal device users belong in the asset management ledger database apparatus 132 include information by which the whitelist integration unit 203 may determine the usage of the malware infected terminal and the department where the user of the malware infected terminal belongs.

Operations that will be performed thereafter are similar to those in the first embodiment. In the configuration shown in each of FIGS. 11 to 13, an inspection object extraction program 207 extracts the main body of malware and a suspicious setting change from the malware infected terminal, based on the whitelist generated by the whitelist integration unit 203.

In this case, orders of inspection (order of inspection among software and the order of inspection among settings) done by the inspection object extraction program 207 may be provided in the whitelist information, as in the first embodiment.

Priorities may be set, with attention paid to commonness of the software and the settings among the terminal devices (operating system, usage, and department where each terminal device belongs).

Alternatively, priorities may be set with attention paid to importance of each software, as in the first embodiment.

As described above, in this embodiment, whitelist information is managed as the usage categorized whitelist information. After the IP address or the MAC address of the malware infected terminal has been notified from the abnormality detection apparatus, the usage of the malware infected terminal is identified, and the whitelist is generated using the usage categorized whitelist information categorized by usage. With this arrangement, the time for generating the whitelist may be reduced.

### Third Embodiment

In the above-mentioned first and second embodiments, the whitelist integration unit 203 generates a whitelist after the IP address (or the MAC address) of the malware infected terminal has been notified from the abnormality detection apparatus 131.

Next, this embodiment will show a method in which, by generating a whitelist in advance, the whitelist integration process is not performed when an abnormality is detected.

Assume that, software SW1 and software SW2 are properly installed in common to the terminal devices 141 and 142, software SW3 and software SW4 are properly installed in common to the terminal devices 143 and 144, and software SW5 and software SW6 are properly installed in common to the terminal devices 145 and 146, for example. In the first embodiment, when the terminal device 141 becomes the malware infected terminal, the terminal whitelist generation apparatus 133 generates a whitelist for the terminal device 141 by integrating whitelist information on the software SW1 and whitelist information on the software SW2.

In this embodiment, before the malware infected terminal is detected, six whitelist information on the software SW1, the software SW2 the software SW3, the software SW4, the software SW5, and the software SW6, is integrated to generate a whitelist which can be used in common to all of the terminal devices.

Then, when the malware infected terminal is detected, inspection on the software and settings on the malware infected terminal is performed, employing the whitelist used in common to all of the terminal devices.

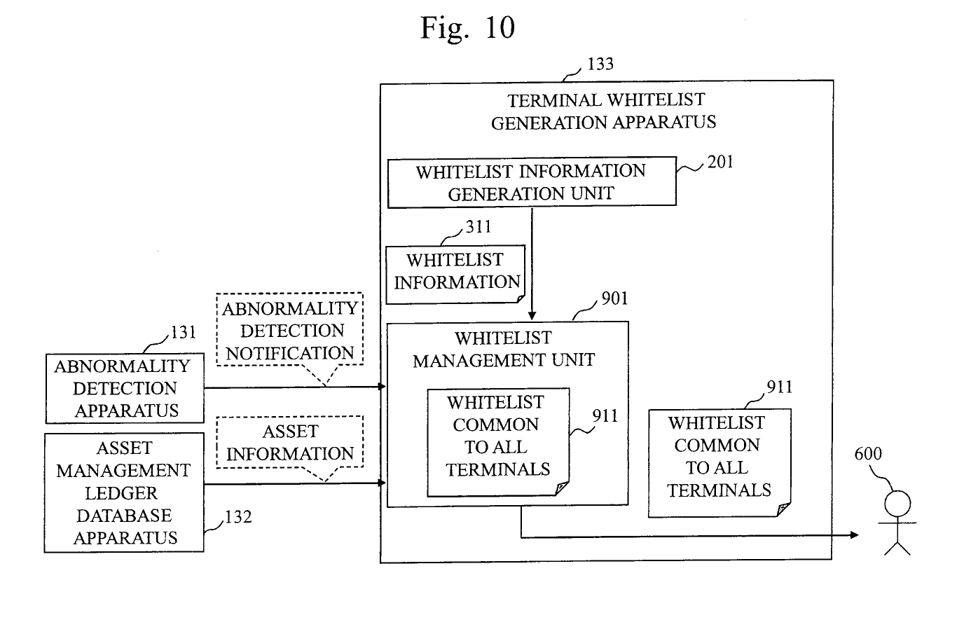

FIG. 10 shows a terminal whitelist generation apparatus 133 for implementing the third embodiment. FIG. 10 corresponds to FIG. 3 shown in the first embodiment.

Referring to FIG. 10, a whitelist management unit 901 includes a function of integrating and managing whitelist information supplied from a whitelist information generation unit 201 as a whitelist common to all terminal devices 911.

The whitelist common to all terminal devices 911 is an aggregation of whitelist information on software installed to respective terminal devices 141 to 146 connected to an enterprise's internal network 101.

Information on the software installed to the respective terminal devices 141 to 146 is obtained by extracting information on the types of the installed software from the asset management ledger database apparatus 132.

Referring to FIG. 10, inputs to a whitelist information generation unit 201 are the same as those in FIG. 3. Thus, illustration of the inputs is omitted.

In other words, illustration of arrows and the like related to the update management system 301, the reference terminal device 134, and generation of the whitelist information shown in FIG. 3 is omitted.

It is assumed that managements on generations over the whitelist information included in the whitelist common to all terminal devices 911 is performed by the whitelist information management unit 901 in the third embodiment as well.

As described above, in the configuration shown in each of FIGS. 11 to 13, when the malware infected terminal is detected by an abnormality detection apparatus 131, the inspection object extraction program 207 extracts the main body of malware and a suspicious setting change from the malware infected terminal, based on the whitelist common to all terminal devices 911, as in the first embodiment.

In this case, as in the first and second embodiments, the whitelist information included in the whitelist is prioritized, and the software and settings that are highly common are preferentially inspected. With this arrangement, efficiency of extracting a malware inspection object may also be improved.

As described above, in this embodiment, whenever whitelist information is newly generated, the whitelist information is aggregated as the whitelist common to all terminal devices, and is managed and stored. With this arrangement, when the malware infected terminal is detected by the abnormality detection apparatus, the already integrated whitelist is output. The time taken until starting the process of extracting a malware inspection object may be reduced.

### Fourth Embodiment

In the first to third embodiments, the terminal whitelist generation apparatus 133 receives notification of the IP address (or the MAC address) of the malware infected terminal from the abnormality detection apparatus 131, prepares the whitelist, and performs the malware inspection object extraction process.

Next, in this embodiment, a description will be directed to a method of using the terminal whitelist generation apparatus 133 for daily preventing malware when there is no abnormal detection by the abnormality detection apparatus 131.

A system configuration diagram in a fourth embodiment is the same as that in FIG. 1. However, only the function of isolating the malware infected terminal of the abnormality detection apparatus 131 is used. Thus, the abnormality detection apparatus 131 does not necessarily need to include the function of detecting an abnormality.

Next, the fourth embodiment will be described.

In the fourth embodiment, the malware inspection object extraction process by the inspection object extraction program 207 based on the whitelist generated by the terminal whitelist generation unit 133 is performed on each terminal connected to the enterprise's internal network 101 at certain intervals set in advance, or when the terminal device is activated.

That is, in this embodiment, the terminal device to be inspected is not the one in which an abnormality has been detected by the abnormality detection apparatus 131. The terminal device that has been activated, or the terminal device that has had a turn at being subject to the inspection is inspected.

In this case, the whitelist used for malware inspection object extraction may be determined based on the priority level as described in the first to third embodiments.

In the malware inspection object detection executing when the terminal device is activated, for example, the whitelist generated based on whitelist information with a high priority level may be used to improve efficiency of the malware inspection object extraction.

When a malware inspection object is extracted in the fourth embodiment, a list of the extracted inspection object and a list of an extracted setting are sent to the terminal whitelist generation apparatus 133 from the terminal device. Then, the list of the extracted inspection object and the list of the extracted setting are automatically sent from the terminal whitelist generation apparatus 133 to a vendor or manually sent by a system manger to the vendor.

When the list of the extracted inspection object and the list of the extracted setting are manually sent by the system manger, the system manager may check whether or not the lists of the extracted inspection object and setting include information such as enterprise's confidential information.

The terminal whitelist generation apparatus 133 may instruct the abnormality detection apparatus 131 to isolate from the enterprise's internal network 101 the terminal device from which the malware inspection object has been extracted.

As described above, by daily performing the malware inspection object extraction for preventing the malware, the malware or an unauthorized setting change may be extracted from the terminal device even if a traffic abnormality is not detected by the abnormality detection apparatus. Accordingly, before the malware gets active, a malware inspection object may be extracted.

In each of the above-mentioned first to fourth embodiments, the description was given about the system that performs the following operations of:

1) generating whitelist information that constitutes a whitelist based on the terminal device (reference terminal device) used as a reference for the terminal devices in the enterprise;

2) managing the generated whitelist information by a predetermined software group;

3) managing the generations of the generated whitelist information;

4) obtaining information on the malware infected terminal device from the asset management ledger database apparatus and generating the whitelist that is referenced for extracting malware from the malware infected terminal device, based on the managed whitelist information; and

5) extracting the malware from the malware infected terminal device, based on the generated whitelist.

The description was given about grouping the whitelist information by software and managing the whitelist information by software.

The description was given about grouping the whitelist information by terminal usage and managing the whitelist information after categorizing the whitelist information on the software for the same usage as a same group.

The description was given about collectively managing all the software allowed to be used and generating the whitelist applicable to all the software.

The description was given about extraction of the malware from the malware infected terminal device, based on the whitelist automatically generated by the terminal whitelist generation apparatus, triggered by detection of a traffic abnormality.

Finally, hardware configuration examples of the terminal whitelist generation apparatus 133, the reference terminal device 134, the terminal device 140, and the inspection object extraction apparatus 160 (hereinafter referred to as the terminal whitelist generation apparatus 133 and the like) shown in the first to fourth embodiments will be described.

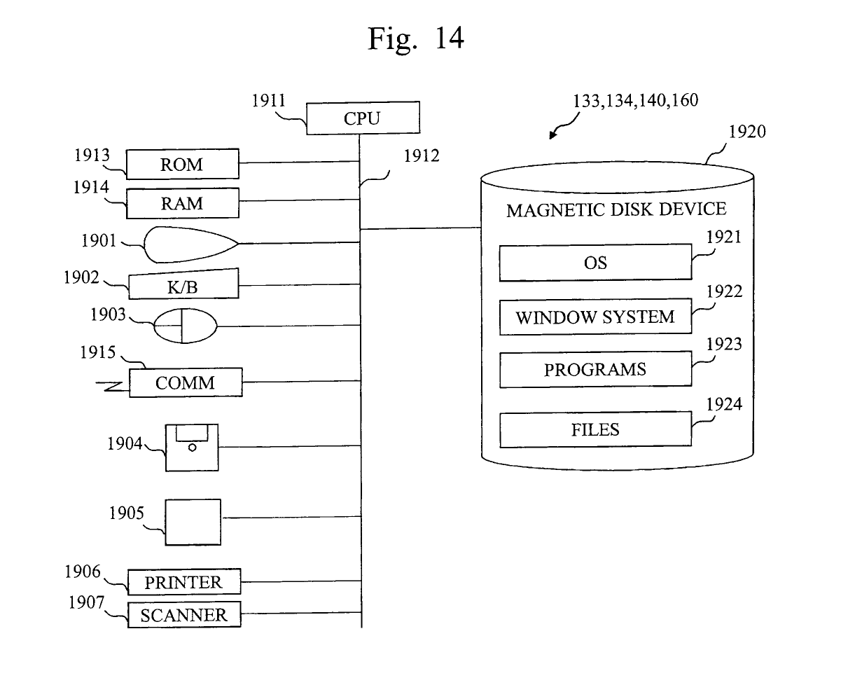

FIG. 14 is a diagram showing an example of hardware resources of the terminal whitelist generation apparatus 133 and the like shown in the first to fourth embodiments.

The configuration in FIG. 14 shows just one example of the hardware configurations of the terminal whitelist generation apparatus 133 and the like. The hardware configurations of the terminal whitelist generation apparatus 133 and the like are not limited to the configurations described in FIG. 14, and different configurations may be used for the terminal whitelist generation apparatus 133 and the like.

Referring to FIG. 14, the terminal whitelist generation apparatus 133 and the like include a CPU 1911 (Central Processing Unit, which is also referred to as a central processing device, a processing unit, an arithmetic operation unit, a microprocessor, a microcomputer, or a processor).

The CPU 1911 is connected to a ROM (Read Only Memory) 1913, a RAM (Random Access Memory) 1914, a communication board 1915, a display device 1901, a keyboard 1902, a mouse 1903, and a magnetic disk device 1920 through a bus 1912, for example, and controls these hardware devices.

Further, the CPU 1911 may be connected to an FDD (Flexible Disk Drive) 1904, a compact disk drive (CDD) 1905, a printer device 1906, and a scanner device 1907. A storage device such as an SSD (Solid State Drive), an optical disk device, a memory card (registered trademark), or a read/write device may be used in place of the magnetic disk device 1920.

The RAM 1914 is an example of a volatile memory. A storage medium such as the ROM 1913, the FDD 1904, the CDD 1905, or the magnetic disk device 1920 is an example of a nonvolatile memory. Each of these media is an example of a memory device.

The “information storage unit” described in the first to fourth embodiments is implemented by the RAM 1914, the magnetic disk device 1920, and the like.

Each of the communication board 1915, the keyboard 1902, the mouse 1903, the scanner device 1907, and the FDD 1904 is an example of an input device.

Each of the communication board 1915, the display device 1901, and the printer device 1906 is an example of an output device.

The communication board 1915 is connected to the enterprise's internal network as shown in FIG. 1.

An operating system (OS) 1921, a window system 1922, programs 1923, and files 1924 are stored in the magnetic disk device 1920.

Each program of the programs 1923 is executed by the CPU 1911, while the CPU 1911 uses the operating system 1921 and the window system 1922.

At least one portion of programs of the operating system 1921 and an application program that is executed by the CPU 1911 is temporarily stored in the RAM 1914.

Various data necessary for processes by the CPU 1911 are stored in the RAM 1914.

A BIOS (Basic Input Output System) program is stored in the ROM 1913, and a boot program is stored in the magnetic disk device 1920.

When the terminal whitelist generation apparatus 133 and the like are activated, the BIOS program in the ROM 1913 and the boot program in the magnetic disk device 1920 are executed. The operating system 1921 is started by the BIOS program and the boot program.

The program for executing the function described as the “--- unit” (the same as below except the “information storage unit”) in the description of the first to fourth embodiments is stored in the programs 1923. The program is read and executed by the CPU 1911.

In the files 1924, information, data, signal values, variable values, and parameters showing results of the processes described as “determination of ---”, “computation of ---”, “comparison of ---”, “check of ---”, “integration of ---”, “generation of ---”, “confirmation of ---”, “specification of ---”, “identification of ---”, “instruction of ---”, “extraction of ---”, “detection of ---”, “updating of ---”, “setting of ---”, “registration of ---”, “selection of ---” are stored as respective items of “---files”, “---databases”.

The “---files” and “---databases” are stored in a storage medium such as a disk and a memory.

The information, the data, the signal values, the variable values, and the parameters stored in the storage medium such as the disk and the memory are loaded into a main memory or a cache memory by the CPU 1911 through a read/write circuit.

Then, the information, the data, the signal values, the variable values, and the parameters that have been read are used for operations of the CPU such as extraction, retrieval, reference, comparison, arithmetic operation, computation, processing, editing, output, printing, and display.

During the operations of the CPU such as extraction, retrieval, reference, comparison, arithmetic operation, computation, processing, editing, output, printing, and display, the information, the data, the signal values, the variable values, and the parameters are temporarily stored in the main memory, a register, the cache memory, a buffer memory, or the like.

An arrow portion in the flowcharts described in the first to fourth embodiments mainly indicates a data or signal input/output.

The data and the signal values are recorded in recording media such as the memory of the RAM 1914, the flexible disk of the FDD 1904, the compact disk of the CDD 1905, the magnetic disk of the magnetic disk device 1920, and other optical disk, minidisk, and DVD.

The data and signals are on-line transmitted through the bus 1912, signal lines, cables, or the other transmission media.

The “---unit” described in this embodiment may be a “---circuit”, an “---apparatus”, or a “---device”. Alternatively, the “---unit” may be a “---step”, a “---procedure”, or a “---process”.

That is, the infection inspection method according to the present invention may be implemented by the steps, the procedures, and the processes shown in the flowcharts described in each of the first to fourth embodiments.

Alternatively, the “---unit” described herein may be implemented by firmware stored in the ROM 1913.

Alternatively, the “---unit” described herein may be implemented only by software, only by hardware such as elements, devices, a substrate, or wires, or by a combination of the software and the hardware, or further, by a combination of the software and the firmware.

The firmware and the software are stored in the recording media such as the magnetic disk, the flexible disk, the optical disk, the compact disk, the minidisk, and the DVD, as the programs.

Each program is read from the CPU 1911 and is executed by the CPU 1911.

That is, the program has a computer function as the “---unit” in the first to fourth embodiments. Alternatively, the program has the procedure or method of the “---unit” in the first to fourth embodiments executed by the computer.

As described above, each of the terminal whitelist generation apparatus 133 and the like shown in the first to fourth embodiments is the computer including the CPU as the processing device, the memories, the magnetic disks, and the like as memory devices, the keyboard, the mouse, and the communication board as input devices, and the display device and the communication board as output devices.

Then, as described above, the functions shown as the “---units” are implemented by these processing device, memory devices, input devices, and output devices.

1. An infection inspection system that performs inspection of a terminal device that may be infected with malware, comprising:
an inspection reference information management unit that stores inspection reference information indicating software properly installed to the terminal device as proper software; and
an inspection execution unit that detects software which is present in the terminal device and inspects whether or not the detected software in the terminal device coincides with the proper software indicated by the inspection reference information stored in the inspection reference information management unit.

2. The infection inspection system according to claim 1, wherein
the inspection reference information management unit stores the inspection reference information indicating setting according to which the proper software normally operates as normal setting; and
the inspection execution unit detects the software which is present in the terminal device and setting of the terminal device, and inspects whether or not the software in the terminal device coincides with the proper software indicated by the inspection reference information and inspects whether or not the detected setting coincides with the normal setting indicated by the inspection reference information.

3. The infection inspection system according to claim 2, wherein
the infection inspection system performs inspection of a plurality of terminal devices each of which may be infected with the malware and to each of which at least one of a plurality of software is properly installed;
the inspection reference information management unit stores a plurality of inspection reference information indicating a plurality of software as a plurality of proper software and indicating normal setting for each proper software, and selects out of the plurality of inspection reference information at least one inspection reference information corresponding to at least one software properly installed to a terminal devices to be inspected specified by the inspection execution unit for the inspection, out of the plurality of terminal devices; and
the inspection execution unit detects software which is present in the terminal device to be inspected and setting of the terminal device to be inspected, inspects whether or not the detected software in the terminal device coincides with the proper software indicated by the inspection reference information selected by the inspection reference information management unit, and inspects whether or not the detected setting coincides with the normal setting indicated by the inspection reference information selected by the inspection reference information management unit.

4. The infection inspection system according to claim 3, further comprising:
an abnormality detection unit that monitors the plurality of terminal devices, detects an occurrence of abnormality in a terminal device, and specifies the terminal device in which the abnormality has occurred as the terminal device to be inspected, and
wherein the inspection reference information management unit selects at least one inspection reference information corresponding to at least one software properly installed to the terminal device to be inspected specified by the abnormality detection unit.

5. The infection inspection system according to claim 2,
wherein
the infection inspection system performs inspection of a plurality of terminal devices each of which may be infected with the malware and each of which belongs to one of a plurality of categories;
the inspection reference information management unit stores the plurality of inspection reference information indicating a plurality of software as a plurality of proper software and indicating normal setting for each proper software;
the inspection reference information management unit groups the plurality of proper software based on attributes of the plurality of proper software, groups the inspection reference information on the proper software classified as a same group, manages each group of the inspection reference information relating each group to either one of categories, and selects the inspection reference information being in the group related to the category to which the terminal device to be inspected specified for the inspection by the inspection execution unit belongs, out of the plurality of inspection reference information; and
the inspection execution unit detects the software which is present in the terminal device to be inspected and the setting of the terminal device to be inspected, inspects whether or not the detected software in the terminal device coincides with the proper software indicated by the inspection reference information selected by the inspection reference information management unit, and inspects whether or not the detected setting coincides with the normal setting indicated by the inspection reference information selected by the inspection reference information management unit.

6. The infection inspection system according to claim 5, further comprising: an abnormality detection unit that monitors the plurality of terminal devices, detects an occurrence of abnormality in a terminal device, and specifies the terminal device in which the abnormality has occurred as the terminal device to be inspected, and
wherein the inspection reference information management unit selects the inspection reference information being in the group corresponding to the category to which the terminal device to be inspected specified by the abnormality detection unit belongs.

7. The infection inspection system according to claim 2,
wherein
the infection inspection system performs inspection of a plurality of terminal devices each of which may be infected with the malware and to each of which at least one of a plurality of software is properly installed;
the inspection reference information management unit stores the inspection reference information indicating a plurality of software as a plurality of proper software and indicating normal setting for each proper software; and
the inspection execution unit detects the software which is present in the terminal device to be inspected which has been specified for the inspection out of the plurality of terminal devices and detects the setting of the terminal device to be inspected, inspects whether or not the detected software in the terminal device coincides with the proper software indicated by the inspection reference information, and inspects whether or not the detected setting coincides with the normal setting indicated by the inspection reference information.

8. The infection inspection system according to claim 7, further comprising:
an abnormality detection unit that monitors the plurality of terminal devices, detects an occurrence of abnormality in a terminal device, and specifies the terminal device in which the abnormality has occurred as the terminal device to be inspected, and
wherein the inspection execution unit detects the software that is present in the terminal device to be inspected and the setting of the terminal device to be inspected.

9. The infection inspection system according to claim 2, further comprising:
a normal setting holding unit which is managed not to be infected with the malware, to which the software properly installed to the terminal device is installed as the proper software, and which holds the setting according to which the proper software normally operates as the normal setting, and
wherein the inspection reference information management unit stores the inspection reference information indicating the proper software installed to the normal setting holding unit and the normal setting held by the normal setting holding unit.

10. An infection inspection method of performing inspection of a terminal device that may be infected with malware, comprising:
storing inspection reference information indicating software properly installed to the terminal device as proper software, by a first computer; and
detecting software which is present in the terminal device and inspecting whether or not the detected software in the terminal device coincides with the proper software indicated by the inspection reference information stored in the first computer, by a second computer.

11. A storage medium capable of being read by a computer, storing:
inspection reference information indicating software properly installed to a terminal device that may be infected with malware, as proper software; and
a program that detects software which is present in the terminal device and inspects whether or not the detected software in the terminal device coincides with the proper software indicated by the inspection reference information.

12. A program that has a computer execute:
inputting inspection reference information indicating software properly installed to a terminal device that may be infected with malware as proper software; and
detecting software which is present in the terminal device and inspecting whether or not the detected software in the terminal device coincides with the proper software indicated by the input inspection reference information.
